(19) United States
(12) Patent Application Publication
(10) Pub. No.: US 2025/0226426 A1
(43) Pub. Date: Jul. 10, 2025

(54) SEPARATOR

(71) Applicant: TOYOTA JIDOSHA KABUSHIKI KAISHA, Toyota-shi (JP)

(72) Inventors: Takenori KOYANAGI, Susono-shi (JP); Naoki TAKEHIRO, Sunto-gun (JP); Kotaro IKEDA, Susono-shi (JP); Yusuke OTSU, Sunto-gun (JP)

(21) Appl. No.: 19/004,783

(22) Filed: Dec. 30, 2024

(30) Foreign Application Priority Data
Jan. 9, 2024 (JP) 2024-001082

(51) Int. Cl. H01M 8/026; H01M 8/0213; H01M 8/0271

(52) U.S. Cl. CPC H01M 8/026; H01M 8/0213; H01M 8/0271

(57) ABSTRACT

To provide a separator configured to suppress a decrease in the power generation performance of fuel cells. A separator for fuel cells, wherein the separator comprises cathode-side gas flow paths; wherein each of the cathode-side gas flow paths comprises flow path portions and restrictor portions; wherein a flow path cross-sectional area of the restrictor portions is smaller than a flow path cross-sectional area of the flow path portions; wherein at least one of the restrictor portions is an upstream-side restrictor portion disposed in an upstream of the cathode-side gas flow paths; wherein at least one of the restrictor portions is a downstream-side restrictor portion disposed in a downstream of the cathode-side gas flow paths; and wherein a flow path cross-sectional area of the at least one upstream-side restrictor portion is larger than a flow path cross-sectional area of the at least one downstream-side restrictor portion.

### TECHNICAL FIELD

The disclosure relates to a separator.

### BACKGROUND

Various studies have been proposed for fuel cells as disclosed in Patent Document 1.
Patent Document 1: Japanese Patent Application Laid-Open (JP-A) No. 2020-107397

Patent Document 1 discloses a unit fuel cell including a restrictor (a part having a small flow path cross-sectional area) in a flow path. There is a possibility that the electrolyte membrane of the fuel cell may be dried on the upstream side of the cathode gas flow path thereof, thereby decreasing the power generation performance of the fuel cell.

### SUMMARY

The disclosure was achieved in light of the above circumstances. An object of the disclosure is to provide a separator configured to suppress a decrease in the power generation performance of fuel cells.

That is, the present disclosure includes the following embodiments.

<1> A separator for fuel cells,
wherein the separator comprises cathode-side gas flow paths;
wherein each of the cathode-side gas flow paths comprises flow path portions and restrictor portions;
wherein a flow path cross-sectional area of the restrictor portions is smaller than a flow path cross-sectional area of the flow path portions;
wherein at least one of the restrictor portions is an upstream-side restrictor portion disposed in an upstream of the cathode-side gas flow paths;
wherein at least one of the restrictor portions is a downstream-side restrictor portion disposed in a downstream of the cathode-side gas flow paths;
wherein a flow path cross-sectional area of the at least one upstream-side restrictor portion is larger than a flow path cross-sectional area of the at least one downstream-side restrictor portion; and
wherein the at least one downstream-side restrictor portion satisfies the following formula (1):

Rc/Rb>1 Formula (1)

(where Rb is a resistance of ribs of the separator to a gas that penetrates under the ribs, and Rc is a resistance of the restrictor portions).

<2> The separator according to <1>, wherein a groove depth of the at least one upstream-side restrictor portion is larger than a groove depth of the at least one downstream-side restrictor portion.

<3> The separator according to <1> or <2>, wherein, when the separator is viewed in plan, the restrictor portions of one of adjacent two of the cathode-side gas flow paths are not adjacent to the restrictor portions of the other one of the adjacent two cathode-side gas flow paths.

<4> The separator according to any one of <1> to <3>,
wherein each of the cathode-side gas flow paths comprises the upstream-side restrictor portions and the downstream-side restrictor portions;
wherein at least one of the upstream-side restrictor portions satisfies the following formula (2):

Rc/Rb≤1 Formula (2); and
wherein at least one of the downstream-side restrictor portions satisfies the above formula (1).

<5> The separator according to any one of <1> to <4>,
wherein each of the cathode-side gas flow paths comprises the upstream-side restrictor portions and the downstream-side restrictor portions;
wherein at least one of the upstream-side restrictor portions satisfies the following formula (2):

Rc/Rb≤1 Formula (2); and
wherein at least one of the downstream-side restrictor portions satisfies the following formula (3):

Rc/Rb≥3 Formula (3).

<6> A fuel cell wherein the fuel cell comprises the separator defined by any one of <1> to <5> as a cathode separator.

<7> The fuel cell according to <6>,
wherein the fuel cell comprises the cathode separator, an anode separator, and a membrane electrode gas diffusion layer assembly disposed between the cathode separator and the anode separator, and
the membrane electrode gas diffusion layer assembly comprises an anode-side gas diffusion layer, an anode catalyst layer, an electrolyte membrane, a cathode catalyst layer and a cathode-side gas diffusion layer in this order, starting from the anode separator side.

The fuel cell system of the present disclosure can suppress a decrease in the power generation performance of fuel cells.

### BRIEF DESCRIPTION OF THE DRAWINGS

In the accompanying drawings,

FIG. 1 is a schematic view showing an example of the power generation unit-side surface of the separator of the present disclosure when viewed in plan;

FIG. 2 is a graph showing an example of the relation between the underrib convective ratios Rc/Rb of the restrictor portions of the cathode-side gas flow paths of the separators of predetermined fuel cells and the concentration overvoltages of the predetermined fuel cells at a current density of 3.8 A/cm²; and

FIG. 3 is a graph showing a relation between the percentage of the restrictor portions having a larger flow path cross-sectional area than that of the normal restrictor portions and the voltage of the fuel cell.

### DETAILED DESCRIPTION

Hereinafter, the embodiments of the present disclosure will be described in detail. Matters that are required to implement the present disclosure (such as common structures and production processes of separators not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relations (such as length, width and thickness) in the drawings do not reflect actual dimensional relations.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and it may be hydrogen. The oxidant gas is a gas containing oxygen, and it may be oxygen, air or the like. In the present disclosure, the fuel gas and the oxidant gas are collectively referred to as “reaction gas” or “gas”.

In the present disclosure, there is provided a separator for fuel cells,
wherein the separator comprises cathode-side gas flow paths;
wherein each of the cathode-side gas flow paths comprises flow path portions and restrictor portions;
wherein the flow path cross-sectional area of the restrictor portions is smaller than the flow path cross-sectional area of the flow path portions;
wherein at least one of the restrictor portions is an upstream-side restrictor portion disposed in the upstream of the cathode-side gas flow paths;
wherein at least one of the restrictor portions is a downstream-side restrictor portion disposed in the downstream of the cathode-side gas flow paths;
wherein the flow path cross-sectional area of the at least one upstream-side restrictor portion is larger than the flow path cross-sectional area of the at least one downstream-side restrictor portion; and
wherein the at least one downstream-side restrictor portion satisfies the following formula (1):

Rc/Rb>1 Formula (1)

(where Rb is the resistance of ribs of the separator to a gas that penetrates under the ribs, and Rc is the resistance of the restrictor portions).

In the gas flow paths of the separator, which are provided with the restrictor portions, the flow path resistance of the gas is increased by a decrease in the flow path cross-sectional area due to the restrictor portions. In the case where the restrictor portions are present in the cathode-side gas flow paths through which the oxidant gas flows and are not present in other cathode-side gas flow paths adjacent to the cathode-side gas flow paths, due to a difference in the flow path resistance between them, a pressure loss difference occurs when the gas flows through the gas flow paths at the same flow rate. Accordingly, to prevent the pressure loss difference, a part of the gas flowing through the cathode-side gas flow paths provided with the restrictor portions, flows into the adjacent cathode-side gas flow paths which is not provided with the restrictor portions and which has a low flow path resistance. The gas flowing into the adjacent cathode-side gas flow paths penetrates under the ribs of the separator and flows through the gas diffusion layer (GDL) adjacent to the separator. Accordingly, since the gas flow through the GDL facilitates substance transport of the membrane electrode assembly and the cathode-side gas flow paths and leads to a decrease in the concentration overvoltage of the fuel cell, the cathode-side gas flow paths of the separator through which the oxidant gas flows, are provided with the restrictor portions. However, in the upstream portion of the cathode-side gas flow paths, in which the relative humidity of the gas is low, the gas flowing through the gas diffusion layer acts to decrease the relative humidity of the electrolyte membrane. As a result, the proton resistance of the electrolyte membrane is increased, thereby causing a decrease in the power generation performance of the fuel cell.

In the present disclosure, the flow path cross-sectional area of the upstream-side restrictor portions of the cathode-side gas flow paths is increased larger than the flow path cross-sectional area of the downstream-side restrictor portions, thereby decreasing the flow path resistance of the cathode-side gas flow paths adjacent to the cathode-side gas flow paths provided with the restrictor portions. Accordingly, the gas flow through the GDL can be suppressed, and the substance transport of the membrane electrode assembly and the cathode-side gas flow paths can be suppressed compared to the prior art. As a result, a decrease in the relative humidity of the electrolyte membrane can be suppressed; the balance of humidity between the upstream side and downstream side of the of the cathode-side gas flow paths can be equalized; an increase in the proton resistance of the electrolyte membrane can be suppressed; and a decrease in the power generation performance of the fuel cell can be suppressed. In the upstream side of the cathode-side gas flow paths, the oxygen partial pressure of the inside of the cathode-side gas flow paths is higher than the downstream side. Accordingly, an increase in the concentration overvoltage caused by increasing the flow path cross-sectional area of the upstream-side restrictor portions, is small; a large resistance overvoltage reduction effect is exerted; and the voltage of the fuel cell is increased.

The separator collects current generated by power generation and functions as a partition wall. In the unit cell of the fuel cell, a pair of separators are usually disposed on both sides of the power generation unit in the stacking direction so as to sandwich the power generation unit. One of the pair of the separators is an anode separator, and the other is a cathode separator.

The separators may be, for example, gas-impermeable dense carbon obtained by compressing carbon, or they may be press-formed metal (such as iron, aluminum and stainless steel).

The separators may have holes constituting a manifold such as a supply hole and a discharge hole for allowing a fluid (such as a reaction gas and a coolant) to flow in the stacking direction of the unit cells.

As the coolant, examples include, but are not limited to, water and a mixed solvent of water and ethylene glycol.

The separator of the present disclosure is the cathode separator. The cathode separator has cathode-side gas flow paths on the power generation unit-side surface. The cathode separator may have ribs, and it may have the cathode-side gas flow paths between the adjacent ribs. The cathode separator may have cooling flow paths and ribs on the surface on the side opposite to the power generation unit-side surface.

The anode separator may have anode-side gas flow paths and ribs on the power generation unit-side surface. The anode separator may have cooling flow paths and ribs on the surface on the side opposite to the power generation unit-side surface. The anode-side gas flow paths are only required to have the flow path portions, and they may have or be free of the restrictor portions.

Each of the cathode-side gas flow paths includes flow path portions and restrictor portions.

The flow path cross-sectional area of the restrictor portions is smaller than the flow path cross-sectional area of the flow path portions.

At least one of the restrictor portions is an upstream-side restrictor portion disposed in the upstream of the cathode-side gas flow paths.

At least one of the restrictor portions is a downstream-side restrictor portion disposed in the downstream of the cathode-side gas flow paths.

In the present disclosure, the flow path portions of the cathode-side gas flow paths means the regions excluding the restrictor portions of the cathode-side gas flow paths. The region beginning from the inlet of the cathode-side gas flow paths to the first restrictor portion, the region between the restrictor portions of the cathode-side gas flow paths, and the region beginning from the last restrictor portion to the outlet of the cathode-side gas flow paths correspond to the flow path portion.

In the present disclosure, the upstream of the cathode-side gas flow paths means a region which begins from the inlet side of the cathode-side gas flow paths and is 50% of the whole region (100%) of the cathode-side gas flow paths (i.e., the half region beginning from the inlet side).

In the present disclosure, the downstream of the cathode-side gas flow paths means a region which begins from the outlet side of the cathode-side gas flow paths and is 50% of the whole region (100%) of the cathode-side gas flow paths (i.e., the half region beginning from the outlet side).

The cathode-side gas flow paths may have the restrictor portions at predetermined intervals.

The flow path cross-sectional area of the at least one upstream-side restrictor portion is larger than the flow path cross-sectional area of the at least one downstream-side restrictor portion. The flow path cross-sectional area of at least one of the upstream-side restrictor portions may be larger than the flow path cross-sectional area of at least one of the downstream-side restrictor portions.

The groove depth of the at least one upstream-side restrictor portion may be larger than the groove depth of the at least one downstream-side restrictor portion. The groove depth of at least one of the upstream-side restrictor portions may be larger than the groove depth of at least one of the downstream-side restrictor portions.

The groove width of the at least one upstream-side restrictor portion may be larger than the groove width of the at least one downstream-side restrictor portion. The groove width of at least one of the upstream-side restrictor portions may be larger than the groove width of at least one of the downstream-side restrictor portions.

When the separator is viewed in plan, the restrictor portions of one of adjacent two of the cathode-side gas flow paths may or may not be adjacent to the restrictor portions of the other one of the adjacent two cathode-side gas flow paths.

The in-plane gas permeability in the gas flow direction of the gas diffusion layer in contact with the cathode-side gas flow paths (i.e., the cathode-side gas diffusion layer) may be equal to or more than the in-plane gas permeability, which is in a direction perpendicular to the gas flow, of the flow path portion of the cathode-side gas flow paths and the in-plane gas permeability, which is in a direction parallel to the gas flow, of the flow path portion thereof.

The gas permeability of the gas diffusion layer may be 5 m³/Pa·s or more and 17 m³/Pa·s or less, for example.

The relative humidity of the oxidant gas supplied to the fuel cell may be less than 100%.

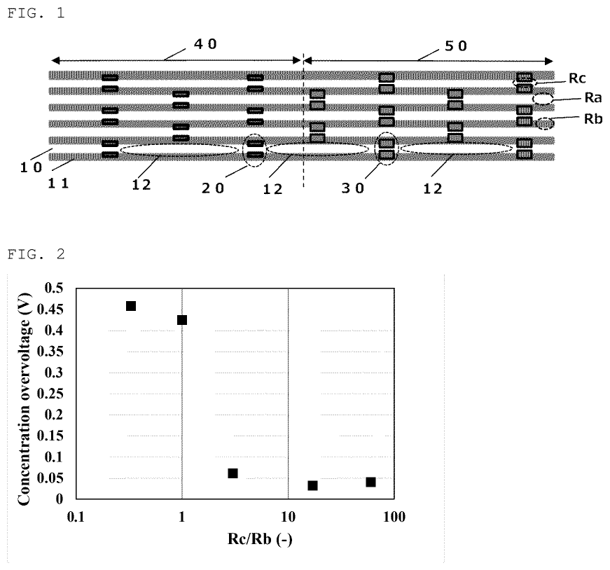

FIG. 1 is a schematic view showing an example of the power generation unit-side surface of the separator of the present disclosure when viewed in plan.

The separator has ribs 11, and it has cathode-side gas flow paths 10 between the adjacent ribs 11. Each of the cathode-side gas flow paths 10 includes flow path portion 12, upstream-side restrictor portions 20 which are disposed in the upstream 40 of the cathode-side gas flow paths 10, and downstream-side restrictor portions 30 which are disposed in the downstream 50 of the cathode-side gas flow paths 10.

The flow path cross-sectional area of the upstream-side restrictor portions 20 disposed in the upstream 40 of the cathode-side gas flow paths 10 is larger than the flow path cross-sectional area of the downstream-side restrictor portions 30 disposed in the downstream 50.

When the separator is viewed in plan, the restrictor portions may be disposed in every other cathode-side gas flow path 10, in the direction perpendicular to the gas flow direction. Accordingly, the gas that cannot pass thorough the restrictor portions penetrates into the gas diffusion layer under the ribs 11 and is likely to flow into the flow path portion 12 of the adjacent cathode-side gas flow paths 10.

The at least one downstream-side restrictor portion satisfies the following formula (1):

Rc/Rb>1 Formula (1)

(where Rb is the resistance of the ribs of the separator to the gas that penetrates under the ribs, and Rc is the resistance of the restrictor portions).

Each of the cathode-side gas flow paths may include the upstream-side restrictor portions and the downstream-side restrictor portions.

At least one of the upstream-side restrictor portions may satisfy the following formula (2):

Rc/Rb≤1 Formula (2).

At least one of the downstream-side restrictor portions may satisfy the above formula (1) or the following formula (3):

Rc/Rb≥3 Formula (3).

In the prior art, there is no study on what needs to be done on the aperture ratio of the restrictor portions to effectively increase the power generation performance of the fuel cell. The increase in the power generation performance of the fuel cell by the restrictor portions cannot be determined by the aperture ratio alone, and it is needed to consider gas distribution in the plane of the separator, including the GDL.

In the present disclosure, in addition to the aperture ratio, an underrib convective ratio Rc/Rb was found as an index of the increase in the power generation performance of the fuel cell, including the influence of the GDL.

The effect of increasing the power generation performance of the fuel cell in the high current range, can be exerted by setting the underrib convective ratio (Rc/Rb) of the restrictor portions formed in the cathode-side gas flow paths of the cathode separator to larger than 1.

In addition, in an environment in which the fuel cell operation temperature is high (i.e., a dry condition), the electrolyte membrane is significantly dried due to excess water discharge under the ribs of the separator, and the power generation performance of the fuel cell cannot be increased. In this environment, accordingly, the underrib convective ratio (Rc/Rb) is set to 1 or less.

The present disclosure is not limited to the case where the underrib convective ratio (Rc/Rb) of all the upstream-side restrictor portions of the cathode-side gas flow paths is 1 or less and the underrib convective ratio (Rc/Rb) of all the downstream-side restrictor portions thereof is 1 or more.

For example, when the underrib convective ratio (Rc/Rb) of at least one of the upstream-side restrictor portions of the cathode-side gas flow paths is 1 or less, the underrib convective ratio (Rc/Rb) of the remaining upstream-side restrictor portions is not particularly limited.

For example, as long as the underrib convective ratio (Rc/Rb) of at least one of the downstream-side restrictor portions of the cathode-side gas flow paths is larger than 1, the underrib convective ratio (Rc/Rb) of the remaining downstream-side restrictor portions is not particularly limited.

For example, the underrib convective ratio (Rc/Rb) of the restrictor portions present between the first upstream-side restrictor portion from the upstream of the cathode-side gas flow paths and the first downstream-side restrictor portion from the downstream thereof, may be in a range of from 1 to 3.

### [Definition of Underrib Convective Ratio (Rc/Rb)]

In the high current range of the fuel cell, the power generation performance of the fuel cell largely decreases due to an increase in the concentration overvoltage. To decrease the concentration overvoltage, it is important to increase the flow rate of the convective gas under the ribs by the restrictor portions. The underrib convective ratio (Rc/Rb) is introduced as the index of the convective gas flow rate under the ribs. The pressure loss that determines the gas flow is determined by the flow path resistance and the gas flow rate. The flow path resistance is deemed as electrical resistance. In FIG. 1, Ra is the resistance determined by the cross-sectional shape of the flow path; Rb is the resistance of the ribs of the separator to the gas that penetrates under the ribs; and Rc is the resistance of the restrictor portions.

For example, as Rc increases with no change in the size of Rb, the convective gas flow rate increases. Accordingly, the convective gas flow rate is determined by Rc and Rb, and the underrib convective ratio Rc/Rb is used as the index of the convective gas flow rate.

From Darcy-Weisbach formulae (A) and (C), the flow path resistance Ra and the resistance Rc of the restrictor portions are represented by the following formula (a) and formula (c), respectively.

$$Δ Pa = ( 32 μ l / {d}^{4} ) \times Qa \qquad Formula ( A )$$

$$Δ Pc = ( 32 μ {l}_{res} / {d}_{res}^{4} ) \times Qc \qquad Formula ( C )$$

$$Ra = ( 32 μ l / {d}^{4} ) \qquad Formula ( a )$$

$$Rc = ( 32 μ {l}_{res} / {d}_{res}^{4} ) \qquad Formula ( c )$$

In the above formulae, ΔP is pressure loss; Q is flow rate; p is air viscosity; l is unit length; d is hydraulic diameter; and res means that the object is the restrictor portions.

From the following formula (B) of Darcy's law, which describes the relation between the pressure and flow rate of the gas in the GDL, the resistance Rb of the ribs of the separator to the gas that penetrates under the ribs, is represented by the following formula (b).

$$Δ Pb = ( {l}_{rib} / {k}_{GDL} ) \times Qb \qquad Formula ( B )$$

$$Rb = {l}_{rib} / {k}_{GDL} \qquad Formula ( b )$$

In the above formulae, k_{GDL} is the gas permeability of the GDL, and l_{rib} is the rib width.

### [Method for Controlling Rb]

The Rb is the function of the rib width (l_{rib}) and the gas permeability of the GDL (k_{GDL}), and the method for controlling the Rb is to control these two parameters. As the method for controlling the Rb to control the underrib convective ratio Rc/Rb in the plane of the separator, examples include, but are not limited to, the following.

1. The rib width along the gas flow direction is changed.

2. The GDL in which the gas permeability increases along the gas flow direction, is used.

3. The gas permeability of the GDL depends on the surface pressure of the separator, and the gas permeability decreases as the surface pressure increases. Accordingly, as the flow path structure of the separator, a flow path structure in which the surface pressure decreases in the gas flow direction, is employed.

### [Relation Between Underrib Convective Ratio Rc/Rb and Concentration Overvoltage]

Using predetermined fuel cells including different separators, the concentration overvoltages of the fuel cells at a current density of 3.8 A/cm² when changing the underrib convective ratios Rc/Rb of the restrictor portions of the cathode-side gas flow paths of the separators to the values of Reference Experimental Examples 1 to 5, were measured.

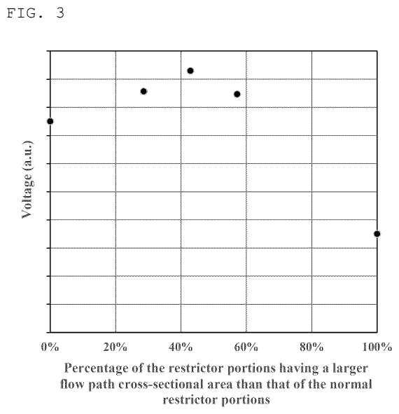

FIG. 2 is a graph showing an example of the relation between the underrib convective ratios Rc/Rb of the restrictor portions of the cathode-side gas flow paths of the separators of the predetermined fuel cells and the concentration overvoltages of the predetermined fuel cells at a current density of 3.8 A/cm².

Table 1 shows the values of the Rc/Rb ratio and the values of the concentration overvoltage of the fuel cell for Reference Experimental Examples 1 to 5.

TABLE 1

| | | Concentration overvoltage |
|---|---|---|
| | Rc/Rb | V @ 3.8 A/cm² |
| Reference Experimental Example 1 | 0.3 | 0.46 |
| Reference Experimental Example 2 | 1 | 0.42 |
| Reference Experimental Example 3 | 3 | 0.06 |
| Reference Experimental Example 4 | 17 | 0.03 |
| Reference Experimental Example 5 | 60 | 0.04 |

As shown in FIG. 2, by setting the underrib convective ratio (Rc/Rb) of the restrictor portions formed in the cathode-side gas flow paths of the cathode separator to larger than 1, the concentration overvoltage is decreased, and the effect of increasing the performance of the fuel cell in the high current range (current density 3.8 A/cm²) is exerted.

Meanwhile, in a low humidity condition, the electrolyte membrane is significantly dried due to excess water discharge under the ribs of the separator, and the effect of decreasing the concentration overvoltage in the case where, as shown in FIG. 2, the underrib convective ratio (Rc/Rb) is larger than 1, is not anticipated. Accordingly, in the low humidity condition, the underrib convective ratio (Rc/Rb) of the restrictor portions may be 1 or less, and it may be 0.3 or more, for example.

In the downstream of the cathode-side gas flow paths of an actual fuel cell, the oxygen concentration is low, and due to produced water, the humidity is high. Accordingly, the underrib convective ratio (Rc/Rb) of at least one of the downstream-side restrictor portions of the cathode-side gas flow paths may be larger than the underrib convective ratio (Rc/Rb) of the upstream-side restrictor portions. The underrib convective ratio (Rc/Rb) of the at least one of the downstream-side restrictor portions of the cathode-side gas flow paths is only required to be larger than 1. It may be 3 or more, or it may be 3 or more and 60 or less.

In the upstream of the cathode-side gas flow paths, the amount of produced water is relatively small; the humidity is relatively low; and the oxygen concentration is relatively high. Accordingly, the underrib convective ratio (Rc/Rb) of at least one of the upstream-side restrictor portions of the cathode-side gas flow paths may be smaller than the underrib convective ratio (Rc/Rb) of the downstream-side restrictor portions. The underrib convective ratio (Rc/Rb) of the at least one of the upstream-side restrictor portions of the cathode-side gas flow paths may be 1 or less, or it may be 0.3 or more and 1 or less, for example.

The separator of the present disclosure is a separator for fuel cells.

The fuel cell includes the separator of the present disclosure as a cathode separator.

The fuel cell may have only one unit fuel cell (unit cell), or it may be a fuel cell stack (stack) composed of a stack of unit cells.

In the present disclosure, both the unit cell and the fuel cell stack may be referred to as a fuel cell.

The number of the stacked unit cells of the fuel cell stack is not particularly limited, and it may be two to several hundreds, for example.

The unit cell may include a power generation unit.

The shape of the power generation unit may be a rectangular shape in a plan view.

The power generation unit may be a membrane electrode assembly (MEA) including an electrolyte membrane and two electrodes sandwiching the electrolyte membrane.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

One of the two electrodes is an anode (a fuel electrode) and the other is a cathode (an oxidant electrode).

Each of the electrodes include a catalyst layer, it may include a gas diffusion layer, as needed. The power generation unit may be a membrane electrode gas diffusion layer assembly (MEGA). In this case, the fuel cell may include the cathode separator, an anode separator, and a membrane electrode gas diffusion layer assembly disposed between the cathode separator and the anode separator.

The membrane electrode gas diffusion layer assembly includes an anode-side gas diffusion layer, an anode catalyst layer, an electrolyte membrane, a cathode catalyst layer and a cathode-side gas diffusion layer in this order.

The anode catalyst layer and the cathode catalyst layer are collectively referred to as “catalyst layer”.

The anode-side gas diffusion layer and the cathode-side gas diffusion layer are collectively referred to as “gas diffusion layer”.

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support on which the catalyst metal is supported (a catalyst-supporting support) may be mixed with the electrolyte.

As the support for supporting the catalyst metal, examples include, but are not limited to, a generally commercially available carbon material such as carbon.

The gas-diffusion layer (GDL) may be composed of a substrate and a mesoporous layer (MPL).

The GDL may include the substrate on a side in contact with the separator and the MPL on a side in contact with the catalyst layer.

The substrate may be a gas-permeable electroconductive member or the like.

As the substrate, examples include, but are not limited to, a carbonaceous porous material such as a carbon cloth and a carbon paper, and a metal porous material such as a metal mesh and a metal foam.

The MPL may contain a mixture of a water-repellent resin such as PTFE and an electroconductive material such as carbon black.

The MPL may contain an antioxidant such as Ce. The generation of radicals can be prevented by the antioxidant.

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and the resin frame forms a seal between the anode separator and the cathode separator in the state that it keeps the membrane electrode assembly in the central region thereof. As the resin frame, for example, a resin such as PE, PP, PET and PEN can be used. The resin frame may be a three-layer sheet composed of an adhesive layer, a substrate layer and an adhesive layer in this order.

The fuel cell stack may include a gasket, a resin sheet and the like between the unit cells for sealing each gas.

### EXAMPLE

A fuel cell including a membrane electrode gas diffusion layer assembly and two separators sandwiching the membrane electrode gas diffusion layer assembly (a cathode separator and an anode separator) was prepared, the membrane electrode gas diffusion layer assembly including an anode-side gas diffusion layer, an anode catalyst layer, an electrolyte membrane, a cathode catalyst layer and a cathode-side gas diffusion layer in this order.

Each of the gas diffusion layers included a MPL layer, and the gas permeability of each gas diffusion layer was set to 9 m³/Pa·s.

Cathode separators were prepared, which were different in the shape of the restrictor portions of the cathode-side gas flow paths. The power generation performance of fuel cells including the cathode separators were compared to each other.

### [Structure of the Cathode-Side Gas Flow Paths of the Cathode Separators]

Along the oxidant gas flow direction, restrictor portions (restrictor portions 1 to 7) were disposed at seven points of the cathode-side gas flow paths. The restrictor portions at the seven points were four upstream-side restrictor portions and three downstream-side restrictor portions. The upstream-side restrictor portions were restrictor portions 1 to 4, and the downstream-side restrictor portions were restrictor portions 5 to 7. The length of the restrictor portions in the gas flow direction was set to 33 mm.

### Comparative Example 1

The underrib convective ratio (Rc/Rb) of all the seven restrictor portions of the cathode-side gas flow paths of the cathode separators was set to 3. The flow path cross-sectional area thereof was limited to 6% with respect to the flow path cross-sectional area (100%) of the flow path portion.

Hereinafter, the restrictor portions of which flow path cross-sectional area was limited to 6% with respect to flow path cross-sectional area (100%) of the flow path portion, may be referred to as “normal restrictor portions”.

Hereinafter, the restrictor portions of which flow path cross-sectional area was limited to 30% with respect to the flow path cross-sectional area (100%) of the flow path portion, may be referred to as “restrictor portions having a larger flow path cross-sectional area than normal restrictor portions”.

In the cathode-side gas flow paths, the percentage of the restrictor portions having a larger flow path cross-sectional area than the normal restrictor portions, was 0%.

### Example 1

Of the seven restrictor portions of the cathode-side gas flow paths of the cathode separators, the underrib convective ratio (Rc/Rb) of the first and second upstream-side restrictor portions from the upstream of the flow paths was set to 1. The flow path cross-sectional area thereof was limited to 30% with respect to the flow path cross-sectional area (100%) of the flow path portion.

The underrib convective ratio (Rc/Rb) of the remaining five restrictor portions was set to 3. The flow path cross-sectional area thereof was limited to 6% with respect to the flow path cross-sectional area (100%) of the flow path portion.

In the cathode-side gas flow paths, the percentage of the restrictor portions having a larger flow path cross-sectional area than the normal restrictor portions, was 29%.

### Example 2

Of the seven restrictor portions of the cathode-side gas flow paths of the cathode separators, the underrib convective ratio (Rc/Rb) of the first to third upstream-side restrictor portions from the upstream of the flow paths was set to 1. The flow path cross-sectional area thereof was limited to 30% with respect to the flow path cross-sectional area (100%) of the flow path portion.

The underrib convective ratio (Rc/Rb) of the remaining four restrictor portions was set to 3. The flow path cross-sectional area thereof was limited to 6% with respect to the flow path cross-sectional area (100%) of the flow path portion.

In the cathode-side gas flow paths, the percentage of the restrictor portions having a larger flow path cross-sectional area than the normal restrictor portions, was 43%.

### Example 3

Of the seven restrictor portions of the cathode-side gas flow paths of the cathode separators, the underrib convective ratio (Rc/Rb) of the first to fourth upstream-side restrictor portions from the upstream of the flow paths was set to 1. The flow path cross-sectional area thereof was limited to 30% with respect to the flow path cross-sectional area (100%) of the flow path portion.

The underrib convective ratio (Rc/Rb) of the remaining three restrictor portions was set to 3. The flow path cross-sectional area thereof was limited to 6% with respect to the flow path cross-sectional area (100%) of the flow path portion.

In the cathode-side gas flow paths, the percentage of the restrictor portions having a larger flow path cross-sectional area than the normal restrictor portions, was 57%.

### Comparative Example 2

The underrib convective ratio (Rc/Rb) of all the seven restrictor portions of the cathode-side gas flow paths of the cathode separators was set to 1. The flow path cross-sectional area thereof was limited to 30% with respect to the flow path cross-sectional area (100%) of the flow path portion.

In the cathode-side gas flow paths, the percentage of the restrictor portions having a larger flow path cross-sectional area than the normal restrictor portions, was 100%.

Table 2 shows the structure of the cathode-side gas flow paths of the cathode separators of Examples 1 to 3 and Comparative Examples 1 and 2. The “aperture ratio” shown in Table 2 means the aperture ratio of the restrictor portions, and it is the percentage (%) of the flow path cross-sectional area of the restrictor portions to the flow path cross-sectional area of the flow path portions when the flow path cross-sectional area of the flow path portions is defined as 100%.

TABLE 2

| | Upstream side | | | | | | | |
|---|---|---|---|---|---|---|---|---|
| | First restrictor | | Second restrictor | | Third restrictor | | Fourth restrictor | |
| | portion | | portion | | portion | | portion | |
| | | Aperture | | Aperture | | Aperture | | Aperture |
| | Rc/Rb | ratio | Rc/Rb | ratio | Rc/Rb | ratio | Rc/Rb | ratio |
| | — | % | — | % | — | % | — | % |
| Comparative | 3 | 6 | 3 | 6 | 3 | 6 | 3 | 6 |
| Example 1 | | | | | | | | |
| Example 1 | 1 | 30 | 1 | 30 | 3 | 6 | 3 | 6 |
| Example 2 | 1 | 30 | 1 | 30 | 1 | 30 | 3 | 6 |
| Example 3 | 1 | 30 | 1 | 30 | 1 | 30 | 1 | 30 |
| Comparative | 1 | 30 | 1 | 30 | 1 | 30 | 1 | 30 |
| Example 2 | | | | | | | | |

| Downstream side | | |
|---|---|---|
| Fifth restrictor | Sixth restrictor | Seventh restrictor |
| portion | portion | portion |

| | | Aperture | | Aperture | | Aperture |
|---|---|---|---|---|---|---|
| | Rc/Rb | ratio | Rc/Rb | ratio | Rc/Rb | ratio |
| | — | % | — | % | — | % |
| Comparative | 3 | 6 | 3 | 6 | 3 | 6 |
| Example 1 | | | | | | |
| Example 1 | 3 | 6 | 3 | 6 | 3 | 6 |
| Example 2 | 3 | 6 | 3 | 6 | 3 | 6 |
| Example 3 | 3 | 6 | 3 | 6 | 3 | 6 |
| Comparative | 1 | 30 | 1 | 30 | 1 | 30 |
| Example 2 | | | | | | |

### [Evaluation of the Power Generation Performance of the Fuel Cells]

The power generation performance of the fuel cells of Examples 1 to 3 and Comparative Examples 1 and 2 was evaluated in the following power generation condition.
Cell temperature: 105° C.
Oxidant gas (air) dew point: 81° C.
Fuel gas (hydrogen) dew point: 74° C.
Oxidant gas flow rate stoichiometric ratio: 1.4
Fuel gas flow rate stoichiometric ratio: 1.25
Gas inlet pressure: 280 kPa abs
Current density: 3.5 A/cm²

As shown in Comparative Example 1 and Examples 1 to 3, with respect to Comparative Example 2 in which the underrib convective ratio (Rc/Rb) of all the restrictor portions of the cathode-side gas flow paths was set to 1, the percentage of the disposed restrictor portions in which the underrib convective ratio (Rc/Rb) was set to 3, was changed. Then, the power generation performance of the fuel cells was evaluated. The results are shown in FIG. 3 and Table 3.

TABLE 3

| | Percentage of the restrictor portions having | |
|---|---|---|
| | a larger flow path cross-sectional area than | |
| | that of the normal restrictor portions | Voltage |
| | % | a.u. |
| Comparative | 0 | 0.55 |
| Example 1 | | |
| Example 1 | 29 | 0.5713 |
| Example 2 | 43 | 0.586 |
| Example 3 | 57 | 0.5693 |
| Comparative | 100 | 0.47 |
| Example 2 | | |

FIG. 3 is a graph showing a relation between the percentage of the restrictor portions having a larger flow path cross-sectional area than that of the normal restrictor portions and the voltage of the fuel cell.

As shown in FIG. 3, the cross-sectional area of the downstream-side restrictor portions disposed in the downstream of the cathode-side gas flow paths was set to 6% with respect to the flow path cross-sectional area (100%) of the flow path portions, and the cross-sectional area of at least two of the upstream-side restrictor portions disposed in the upstream of the cathode-side gas flow paths was set to 30% with respect to the flow path cross-sectional area (100%) of the flow path portions. As a result, an increase in fuel cell voltage was confirmed.

Compared to Comparative Example 2 in which the underrib convective ratio (Rc/Rb) of all the restrictor portions of the cathode-side gas flow paths was 1, in the case of Comparative Example 1 in which the underrib convective ratio (Rc/Rb) of all the restrictor portions of the cathode-side gas flow paths was 3, the fuel cell voltage was increased by a decrease in concentration overvoltage. In Example 2 in which the underrib convective ratio (Rc/Rb) of the first to third upstream-side restrictor portions from the upstream of the flow paths was set to 1 in consideration of dryness in the upstream of the cathode-side gas flow paths resulting from moisture deficiency, the fuel cell voltage was confirmed to be increased by a decrease in resistance overvoltage in addition to a decrease in concentration overvoltage.

### REFERENCE SIGNS LIST

10. Cathode-side gas flow path
11. Rib
12. Flow path portion
20. Upstream-side restrictor portion
30. Downstream-side restrictor portion
40. Upstream
50. Downstream

1. A separator for fuel cells,
wherein the separator comprises cathode-side gas flow paths;
wherein each of the cathode-side gas flow paths comprises flow path portions and restrictor portions;
wherein a flow path cross-sectional area of the restrictor portions is smaller than a flow path cross-sectional area of the flow path portions;
wherein at least one of the restrictor portions is an upstream-side restrictor portion disposed in an upstream of the cathode-side gas flow paths;
wherein at least one of the restrictor portions is a downstream-side restrictor portion disposed in a downstream of the cathode-side gas flow paths;
wherein a flow path cross-sectional area of the at least one upstream-side restrictor portion is larger than a flow path cross-sectional area of the at least one downstream-side restrictor portion; and
wherein the at least one downstream-side restrictor portion satisfies the following formula (1):
Rc/Rb>1 Formula (1)
(where Rb is a resistance of ribs of the separator to a gas that penetrates under the ribs, and Rc is a resistance of the restrictor portions).

2. The separator according to claim 1, wherein a groove depth of the at least one upstream-side restrictor portion is larger than a groove depth of the at least one downstream-side restrictor portion.

3. The separator according to claim 1, wherein, when the separator is viewed in plan, the restrictor portions of one of adjacent two of the cathode-side gas flow paths are not adjacent to the restrictor portions of the other one of the adjacent two cathode-side gas flow paths.

4. The separator according to claim 1,
wherein each of the cathode-side gas flow paths comprises the upstream-side restrictor portions and the downstream-side restrictor portions;
wherein at least one of the upstream-side restrictor portions satisfies the following formula (2):
Rc/Rb≤1 Formula (2); and
wherein at least one of the downstream-side restrictor portions satisfies the above formula (1).

5. The separator according to claim 1,
wherein each of the cathode-side gas flow paths comprises the upstream-side restrictor portions and the downstream-side restrictor portions;
wherein at least one of the upstream-side restrictor portions satisfies the following formula (2):
Rc/Rb≤1 Formula (2); and
wherein at least one of the downstream-side restrictor portions satisfies the following formula (3):
Rc/Rb≥3 Formula (3).

6. A fuel cell wherein the fuel cell comprises the separator defined by claim 1 as a cathode separator.

7. The fuel cell according to claim 6,
wherein the fuel cell comprises the cathode separator, an anode separator, and a membrane electrode gas diffusion layer assembly disposed between the cathode separator and the anode separator, and
the membrane electrode gas diffusion layer assembly comprises an anode-side gas diffusion layer, an anode catalyst layer, an electrolyte membrane, a cathode catalyst layer and a cathode-side gas diffusion layer in this order, starting from the anode separator side.
